(19) United States
(12) Patent Application Publication
(10) Pub. No.: US 2021/0056551 A1
(43) Pub. Date: Feb. 25, 2021

(54) ELECTRONIC TRANSACTION PROCESSING

(71) Applicant: BEIJING SANKUAI ONLINE TECHNOLOGY CO., LTD, Beijing (CN)

(72) Inventors: Xiaojing XIE, Beijing (CN); Xiaoting YE, Beijing (CN); Shanfeng SUN, Beijing (CN); Yuping LUO, Beijing (CN); Jiaquan LUO, Beijing (CN); Junjun ZHAO, Beijing (CN)

(21) Appl. No.: 17/092,762

(22) Filed: Nov. 9, 2020

Related U.S. Application Data
(63) Continuation-in-part of application No. PCT/CN2018/121276, filed on Dec. 14, 2018.

(30) Foreign Application Priority Data
May 7, 2018 (CN) 201810426930.1
Jun. 28, 2018 (CN) 201810686981.8

(51) Int. Cl. G06Q 20/40; H03M 7/40; G06N 5/02

(52) U.S. Cl. CPC G06Q 20/4014; G06Q 20/4016; G06N 5/025; H03M 7/40; G06Q 20/407

(57) ABSTRACT

An electronic transaction processing method, including: receiving a self-verification request, sent by a payee terminal, for an order transaction; and determining whether transaction verification information carried in the self-verification request matches verification information of the order transaction, wherein the verification information of the order transaction is sent to an associated payer account when the order transaction is successful; and if both match, not carrying out reversal processing.

### CROSS REFERENCE TO RELATED APPLICATIONS

This patent application is a continuation-in-part of an international Application No. PCT/CN2018/121276 entitled “ELECTRONIC TRANSACTION PROCESSING”, filed Dec. 14, 2018. The international application claims priority to Chinese Patent Application No. 201810426930.1, entitled “ELECTRONIC TRANSACTION PROCESSING METHOD, SERVER, TRANSACTION TERMINAL, AND SYSTEM”, filed on May 7, 2018, and Chinese Patent Application No. 201810686981.8, entitled “ELECTRONIC TRANSACTION PROCESSING METHOD, SERVER, TRANSACTION TERMINAL, AND SYSTEM”, filed on Jun. 28, 2018. All of these applications are incorporated herein by reference in their entireties.

### TECHNICAL FIELD

The present disclosure relates to the field of computer technologies, and specifically to electronic transaction processing.

### BACKGROUND

During an electronic transaction, for example, during a transaction by using a point of sale (POS) system, and in a case that a transaction state is uncertain due to a timeout in response to a transaction processing request sent by a POS terminal or other reasons, the POS terminal automatically sends a reversal request to a background to cancel the original transaction, and performs a new transaction when a reversal is completed. Reversal is a remedy adopted by the system to protect a user's interest when the system considers that a transaction is likely to fail. During an electronic transaction, in a case that a transaction state is uncertain, a reversal packet needs to be sent to a receiver of the transaction processing request to cancel the transaction processing request.

### SUMMARY

The present disclosure provides an electronic transaction processing method, a server, a payee terminal, and a system, to improve the transaction efficiency and reduce the reversal rate.

According to one aspect of the present disclosure, an electronic transaction processing method is provided, which is applied to a server and includes:

receiving a self-verification request sent by a payee terminal for an order transaction;

determining whether transaction verification information carried in the self-verification request matches verification information of the order transaction stored in the server, where the verification information of the order transaction is sent to an associated payer account when the order transaction is successful; and

if the transaction verification information matches the verification information of the order transaction, not carrying out reversal processing.

According to another aspect of the present disclosure, an electronic order transaction processing method is provided, which is applied to a payee terminal and includes:

sending a transaction processing request including order information to a server; providing, in a case that a transaction result returned by the server for the transaction processing request is not received in a first target duration, an input interface of transaction verification information; and obtaining transaction verification information through the input interface; and

adding the obtained transaction verification information into a self-verification request, and sending the self-verification request to the server.

According to still another aspect of the present disclosure, a reversal processing system is provided, including:

a server, including a processor and a storage medium configured to store executable instructions of the processor, the processor being configured to execute instructions stored in the storage medium, to implement the following steps:

receiving a self-verification request sent by a payee terminal for an order transaction;

determining whether transaction verification information carried in the self-verification request matches verification information of the order transaction stored in the server, where the verification information of the order transaction is sent to an associated payer account when the order transaction is successful; and

if the transaction verification information matches the verification information of the order transaction, not carrying out reversal processing; and

at least one payee terminal, including a processor and a storage medium configured to store executable instructions of the processor, the processor being configured to execute instructions stored in the storage medium, to implement the following steps:

sending a transaction processing request including order information to a server;

if a transaction result returned by the server for the transaction processing request is not received in a first target duration,

providing an input interface of transaction verification information, and obtaining the transaction verification information through the input interface;

adding the obtained transaction verification information into a self-verification request;

sending the self-verification request to the server.

### BRIEF DESCRIPTION OF THE DRAWINGS

FIG. 1 is a flowchart of an electronic transaction processing method according to an embodiment of the present disclosure.

FIG. 2 is a flowchart of an electronic transaction processing method according to another embodiment of the present disclosure.

FIG. 3 is a schematic diagram of an information obtaining page according to an embodiment of the present disclosure.

FIG. 4 is a flowchart of an electronic transaction processing method according to still another embodiment of the present disclosure.

FIG. 5 is a schematic diagram of a cashiering success page according to an embodiment of the present disclosure.

FIG. 6 is a schematic diagram of a result unknown page according to an embodiment of the present disclosure.

FIG. 7 is a schematic diagram of a self-verification success page according to an embodiment of the present disclosure.

FIG. 8 is a schematic diagram of a self-verification failure page according to an embodiment of the present disclosure.

FIG. 9 is a schematic diagram of a self-verification failure page according to another embodiment of the present disclosure.

FIG. 10 is a schematic diagram of a reversal success page according to an embodiment of the present disclosure.

FIG. 11 is a structural block diagram of a server according to an embodiment of the present disclosure.

FIG. 12 is a structural block diagram of a payee terminal according to an embodiment of the present disclosure.

FIG. 13 is a structural block diagram of a reversal processing system according to an embodiment of the present disclosure.

FIG. 14 is a flowchart of an electronic transaction processing method according to an embodiment of the present disclosure.

FIG. 15 is a schematic flowchart of an electronic transaction processing method according to another embodiment of the present disclosure.

FIG. 16 is a block diagram of a server according to an embodiment of the present disclosure.

FIG. 17 is a block diagram of a payee terminal according to an embodiment of the present disclosure.

FIG. 18 is a block diagram of a reversal processing system according to an embodiment of the present disclosure.

### DETAILED DESCRIPTION

To make the objectives, features, and advantages of the present disclosure more obvious and comprehensible, the present disclosure is described below with reference to the accompanying drawings and specific implementations. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

In a process of electronic transaction, a transaction usually involves two main bodies, that is, a payee terminal and a server located at the background. For example, the payee terminal is a POS terminal used by a merchant, and the server is a server providing a service for any application (APP). Optionally, the any APP is a resource transfer APP, a shopping APP, or the like, but the present disclosure is not limited thereto. For ease of understanding, the transaction process is briefly described herein. When the payee terminal initiates a transaction, corresponding order information (for example, an order number that can uniquely identify a transaction) is generated, and the order information is carried in a transaction processing request to be sent to the server. When receiving the transaction processing request including the order information sent by the payee terminal, the server processes a corresponding transaction and stores a transaction result, then returns the transaction result to the payee terminal that sends the transaction processing request, for the payee terminal to view the transaction result.

However, if the payee terminal does not receive the transaction result after requesting the server to process a transaction, to avoid a dispute between the payee and the payer, the payee terminal automatically initiates a reversal to cancel the transaction, but the payee terminal still needs to send a transaction processing request to the server again after the reversal, to request the server to process a corresponding transaction, which may result in low transaction efficiency, pro-longed transaction time, and bad payer experience. If a large scale of failures occur, and the transaction result further cannot be obtained through repeated transactions, as a result, not only the reversal rate is excessively high and a large quantity of resources are consumed, but also the payer may directly cancel the consumption, further causing losses to the merchant and affecting service incomes.

Based on this, the embodiments of the present disclosure provide an electronic transaction processing method, a server, a payee terminal, and a system, to change an automatic reversal procedure of transaction, and the merchant manually triggers a reversal procedure when the payee terminal does not receive a transaction result, avoid the loss of funds caused by an automatic reversal during a communication failure, help the merchant increase service incomes, reduce the reversal rate of the electronic transaction, and improve payer satisfaction.

### Embodiment 1

FIG. 1 is a flowchart of an electronic transaction processing method according to an embodiment of the present disclosure. Referring to FIG. 1, the electronic transaction processing method according to this embodiment is performed by a server and includes the following steps.

Step S101. A server receives a self-verification request sent by a payee terminal for an order transaction.

For example, the transaction in this embodiment is a payment act, any payment act inside or outside the system can form a transaction, an order is a record of the existence of the transaction, and processing the order is a representation form of a transaction. A common transaction case is that: one party (for example, a merchant) provides a service and charges service fees as a payee; and the other party (for example, a consumer) pays the service fees and obtains the service as a payer.

Step S102. The server determines whether transaction verification information carried in the self-verification request matches verification information of the order transaction, where the verification information of the order transaction is sent to an associated payer account when the order transaction is successful; and does not carry out reversal processing if the transaction verification information matches the verification information of the order transaction. The self-verification herein is an operation to prove, in a case that the payee terminal does not receive information returned by the server end indicating whether the transaction is successful, to the server that the transaction at a terminal side is already successful.

If the order transaction is successful, the verification information is not only stored in the server, but also sent to an associated payer account. Therefore, the payer can provide verification information of the order transaction state for the payee terminal, for the payee terminal to use the verification information as transaction verification information, and sends a self-verification request to the server.

As shown in FIG. 1, according to the electronic transaction processing method in this embodiment, the server receives the self-verification request of the payee terminal, and matches the transaction verification information carried in the self-verification request with the verification information of the order transaction stored in the server, and does not carry out reversal processing if both match. Therefore, an automatic reversal is prevented from being initiated when the payee terminal considers the transaction unsuccessful, thereby improving the transaction efficiency and user's experience.

Optionally, that the server does not carry out reversal processing means that: after determining that transaction verification information carried in a self-verification request of an order transaction matches verification information stored in a server, even though a reversal request of the order transaction sent by a payee terminal is received, the server does not carry out reversal processing. Optionally, that the server does not carry out reversal processing means that: a payee terminal does not send a reversal request to the server any more, therefore, the server does not carry out reversal processing. For example, if state information in a self-verification request matches verification information of an order transaction, the server sends a self-verification success message to a payee terminal, and the payee terminal no longer sends a reversal request to the server after receiving the self-verification success message.

In an embodiment of the present disclosure, the method shown in FIG. 1 further includes: carrying out, by the server, reversal processing in a case that the transaction verification information carried in the self-verification request does not match the verification information of the order transaction.

That is, after receiving the self-verification request sent by the payee terminal, the server determines whether to carry out reversal processing. For example, if the transaction verification information carried in the self-verification request matches the verification information of the order transaction, the reversal processing is not carried out; and if the transaction verification information carried in the self-verification request does not match the verification information of the order transaction, the reversal processing is carried out. In this way, the self-verification procedure of the transaction is provided, which makes up for the singleness and the shortage of an automatic reversal procedure, improves transaction efficiency, and satisfies the requirement of diversity.

In an embodiment of the present disclosure, the foregoing carrying out reversal processing includes: determining a corresponding order transaction according to the order information included in the received reversal request sent by the payee terminal, canceling the order transaction, and adding a reversal mark for the canceled order transaction.

Optionally, the server directly carries out reversal processing after determining that transaction verification information carried in a self-verification request does not match verification information of an order transaction

Optionally, after receiving the reversal request sent by the payee terminal, the server determines a corresponding order transaction according to the order information included in the reversal request, then determines whether the order transaction is already performed, and rolls back the order transaction and adds a manual reversal mark for the order transaction in a case that the server end processes successfully; if the server end does not process successfully, no processing is performed, and then the reversal result is returned to the payee terminal. The rolling back the order transaction means: transferring, after transferring resource from a payer account to a payee account, the resource from the payee account back to the payer account.

It should be noted that, the server determines that the reversal is initiated by the payee terminal and adds a reversal mark (for example, “manual reversal”) for a corresponding order transaction, and the manual reversal mark herein is different from the automatic reversal mark. Adding the manual reversal mark helps the server collect statistics on the quantity of manual reversals initiated by the payee terminal, and provides reference for subsequent improvement and decision making.

In an embodiment of the present disclosure, determining whether the transaction verification information carried in the self-verification request matches the verification information of the order transaction in the foregoing step S102 includes: determining whether the transaction verification information carried in the self-verification request is consistent with the verification information and whether the transaction verification information is valid; determining, in a case that the transaction verification information is consistent with the verification information and the transaction verification information is valid, that the transaction verification information matches the verification information; and determining, if the transaction verification information is not consistent with the verification information or the transaction verification information is invalid, that the transaction verification information does not match the verification information.

It should be noted that, when processing an order transaction, the server stores information about the transaction. When the order transaction is successful, the server stores the verification information of the order transaction, and sends the verification information of the order transaction to the associated payer account.

Subsequently, after receiving the self-verification request sent by the payee terminal, the server extracts the transaction verification information in the self-verification request, determines the validity of the transaction verification information, and determines whether the transaction verification information is consistent with the verification information sent to the associated payer account when the order transaction is successful. If it is determined that the transaction verification information in the self-verification request is valid (for example, a format of the transaction verification information satisfies a target information format), the valid transaction verification information is compared with the verification information of the order transaction. If the transaction verification information carried in the self-verification request is consistent with the verification information of the order transaction, it may be determined that the transaction verification information matches the verification information of the order transaction, which indicates that the current order transaction requesting a self-verification is a successful order transaction, then the server may return a self-verification success message to the payee terminal.

That the transaction verification information is consistent with the verification information of the order transaction includes two cases. One case is that the transaction verification information is completely the same as the verification information of the order transaction. For example, the verification information of the order transaction is 414326, six numbers in total, and the transaction verification information in the received self-verification request is also the six numbers, namely, 414326, which indicates that the transaction verification information is consistent with the verification information of the order transaction. The other case is that the transaction verification information is in a one-to-one correspondence to the verification information of the order transaction. For example, the verification information of the order transaction is: transaction amount and transaction time. The transaction verification information in the self-verification request received by the server is xx RMB, x month x day x minute. There is only one order transaction whose transaction time and transaction amount uniquely correspond to the transaction verification information in the successful order transactions of the server end. It can also indicate that the transaction verification information is consistent with the verification information of the order transaction.

If the transaction verification information in the self-verification request is invalid (for example, the format of the transaction verification information does not satisfy the target information format), or the transaction verification information is not consistent with verification information of any order transaction stored in the server, it may be determined that the current order transaction requesting a self-verification fails. In this case, the server returns a self-verification failure message to the payee terminal.

In an embodiment of the present disclosure, the method shown in FIG. 1 further includes: querying, if a query request including the order information sent by the payee terminal is received, a transaction result of a corresponding order transaction according to the query request, and returning the transaction result to the payee terminal.

That is, the server further receives the query request sent by the payee terminal, and the query request is a request sent by the payee terminal to query a transaction result. In an actual application, due to a network or system failure, or another reason, it may take quite a long time to query a transaction result. Consequently, the server cannot return the transaction result to the payee terminal in time. In this case, after receiving the query request sent by the payee terminal, the server queries a transaction result of an order transaction corresponding to the order information according to the order information, and returns the query result to the payee terminal.

It may be understood that, the query result may be that the transaction result of the order transaction is found, or may be that the transaction result of the order transaction is not found. The case that the transaction result of the order transaction is found is alternatively divided into two cases: the order transaction processing result is found successful, and the order transaction processing result is found failed.

### Embodiment 2

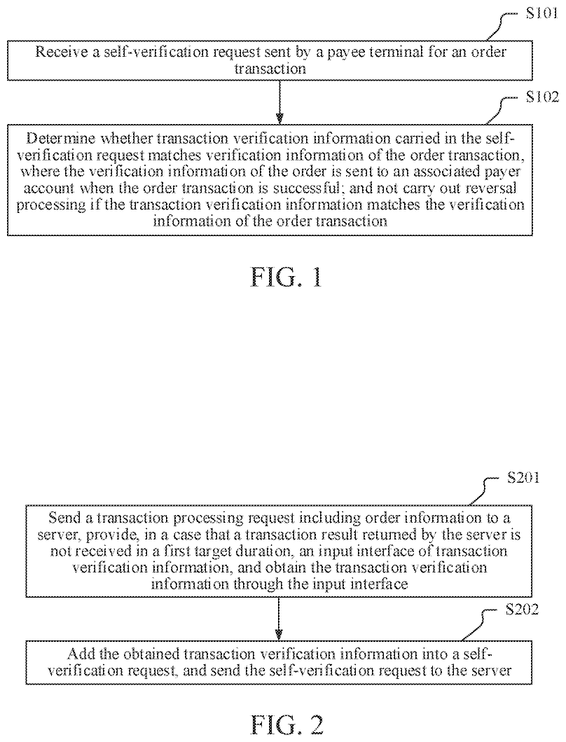

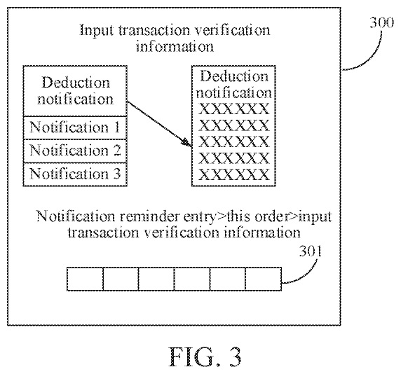

FIG. 2 is a flowchart of an electronic transaction processing method according to another embodiment of the present disclosure. Referring to FIG. 2, the electronic transaction processing method according to this embodiment is performed by a payee terminal and includes the following steps.

Step S201. A payee terminal sends a transaction processing request including order information to a server, provides, in a case that a transaction result returned by the server is not received in a first target duration, an input interface of transaction verification information, and obtains the transaction verification information through the input interface. The transaction processing request is used for instructing the server to process an order transaction according to order information. For example, the order information includes a payer account, a payee account, and a quantity of transferred resources. The processing an order transaction according to order information means: transferring the quantity of resources from the payer account to the payee account.

Step S202. The payee terminal adds the obtained transaction verification information into a self-verification request, and sends the self-verification request to the server.

As shown in FIG. 2, in the electronic transaction processing method according to this embodiment, when the payee terminal does not receive the transaction result returned by the server, the payee terminal provides the input interface of the transaction verification information, obtains the transaction verification information through the input interface, adds the obtained transaction verification information into the self-verification request, sends the self-verification request to the server for a self-verification. In this way, the reversal rate is prevented from being excessively high due to an automatic reversal when the transaction result returned by the server is not received, and the problem of affecting the payer's experience is avoided, thereby improving the smoothness of the transaction.

The self-verification is based on the following case that occurs in a large quantity of on-the-spot transactions: the payee terminal sends an order transaction to a background server successfully, for the background server to process the order transaction, the payer account already deducts the payment but the payee terminal does not receive the transaction result returned by the server, and it is uncertain whether the background server processes the order transaction successfully. Because the payer already deducts the payment, if this order transaction is canceled by carrying out reversal processing at this time, and a processing procedure of the order transaction is required to be performed again after the reversal, a large quantity of resources are consumed, which also affects the payer's experience.

For this case, the payee terminal initiates a self-verification according to this embodiment. Optionally, the payee terminal obtains the transaction verification information, and the transaction verification information is used for checking whether the corresponding order transaction is processed. In the foregoing step S201, obtaining the transaction verification information through the input interface includes: obtaining the transaction verification information in a deduction notification of an associated payer account through the input interface. This is because: if the payer account already deducts the payment, a payer terminal receives the deduction notification delivered by the server. In this case, the payee terminal provides the input interface of the transaction verification information. For example, the payee terminal opens a code scanning function, and obtains the transaction verification information (for example, a barcode, a two-dimensional code, and another graphic code) from the deduction notification of a payer terminal.

In another example, as shown in FIG. 3, the payee terminal shows an information obtaining page 300. The information obtaining page 300 includes an input interface 301 of transaction verification information, for a merchant or a payer to input a character string in a deduction notification in the input interface, and the payee terminal obtains the character string used for self-verification in the deduction notification through the input interface. Optionally, the character string is a series of numbers, a series of letters, a combination of numbers and letters, or the like.

In an embodiment of the present disclosure, after obtaining the transaction verification information, the payee terminal sends the self-verification request including the transaction verification information and the order information to the server. The payee terminal receives the message sent by the server after the determination, and outputs prompt information of a successful order transaction if a self-verification success message returned by the server is received; and outputs, if a self-verification failure message returned by the server is received, prompt information that the order transaction fails and a reversal is performed.

That is, the payee terminal outputs different prompt information according to whether the self-verification is successful, to prompt the merchant for subsequent operations. For example, if the payee terminal receives the self-verification failure message sent by the server, the payee terminal outputs prompt information that the order transaction fails and a reversal is performed, for the user to learn of the self-verification result in time. The reversal is performed when the self-verification fails. For an order transaction on which the user initiates the reversal at the payee terminal, the user asks, after the reversal is performed, the payer to repay the order according to the reversal processing result. Then the transaction procedure ends. The user herein refers to a merchant, and the payer herein refers to a consumer purchasing services from the merchant.

In an actual application, due to a network reason, the payee terminal cannot receive the transaction result of the order transaction in time. In this case, the method shown in FIG. 2 further includes: sending, in a case that the transaction result returned by the server is not received in a first target duration, a query request including the order information to the server, and performing, in a case that a transaction result of an order transaction is still not found in a second target duration, the step of providing an input interface of transaction verification information.

It should be noted that, in this embodiment, if the transaction result returned by the server is not received by the payee terminal after the transaction processing request of the order transaction is sent, the payee terminal first sends a query request to the server to query the transaction result, and the self-verification is not performed in a case that the transaction result is found. If the transaction result is still not found in the second target duration (the payee terminal can set a query duration, that is, set the second target duration, for example, 20 seconds), the payee terminal provides the input interface of the transaction verification information to obtain the transaction verification information for the self-verification. In this case, the self-verification or the reversal is prevented from being triggered in a case that the order transaction can be normally processed, thereby saving system overheads and resources, shortening transaction time, and improving the transaction success rate.

Optionally, the first target duration and the second target duration are any durations.

In addition, in an embodiment, a reversal option is provided in a case that the transaction result returned by the server is not received in the first target duration, and a reversal request including the order information is sent to the server if the reversal option is triggered.

That is, in a case that the transaction result returned by the server is not received by the payee terminal, the transaction terminal can further provide a reversal option to initiate a reversal procedure, to provide a plurality of selections for the user. The self-verification and the reversal are supported at the same time, thereby satisfying complex situations of the transaction spot and various requirements of users.

In an actual application, the payee terminal determines, after the transaction result is found, whether the order transaction is successful according to the found transaction result. The payee terminal displays a transaction success page when the transaction is successful, and the payee terminal displayed a transaction failure page when the transaction fails, which helps the user to learn of the transaction result in time.

### Embodiment 3

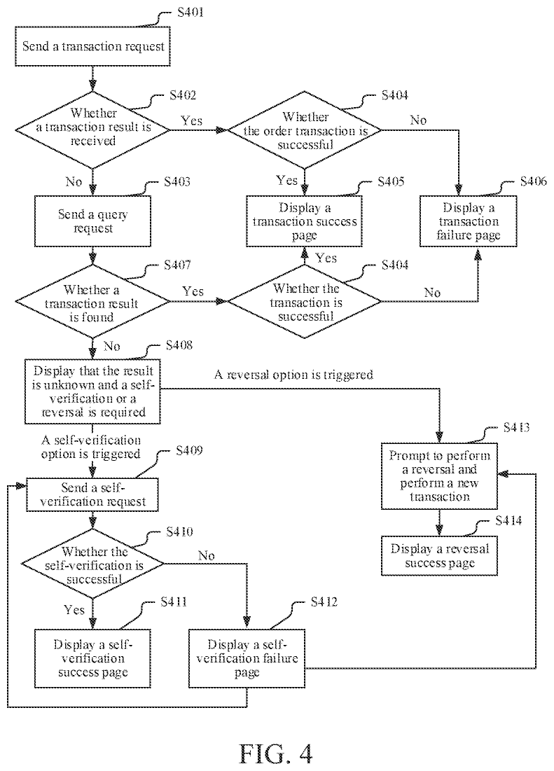

FIG. 4 is a flowchart of an electronic transaction processing method according to still another embodiment of the present disclosure. The electronic transaction processing method according to this embodiment is performed by a payee terminal (for example, a POS terminal) and includes the following steps.

Step S401. A payee terminal sends a transaction processing request.

The payee terminal initiates a transaction, and sends a transaction processing request including order information to a server.

Step S402. The payee terminal determines whether a transaction result is received; and performs step S404 if the transaction result is received, and performs step S403 if the transaction result is not received.

Due to network or other reasons, the payee terminal may not receive the transaction result indicating a transaction state. Therefore, in this step, the payee terminal determines whether the transaction result is received; and performs step S404 if the transaction result is received, and performs step S403 if the transaction result is not received.

Step S403. The payee terminal sends a query request, and performs step S407.

In this step, the payee terminal sends a query request including the order information to a server, to query the transaction result. The transaction duration herein is 10 seconds, 60 seconds, or the like.

Step S404. The payee terminal determines whether the order transaction is successful, performs step S405 if the order transaction is successful, and performs step S406 if the order transaction fails.

In this step, under a premise that the transaction result is received, whether the order transaction is successful is determined according to the transaction result. In an actual application, due to misoperation, insufficient account balance, network, and other reasons, the order transaction may fail, and whether the order transaction is successfully processed is determined according to the transaction result in this step, for the user to learn whether the order transaction is successful.

Step S405. The payee terminal displays a transaction success page.

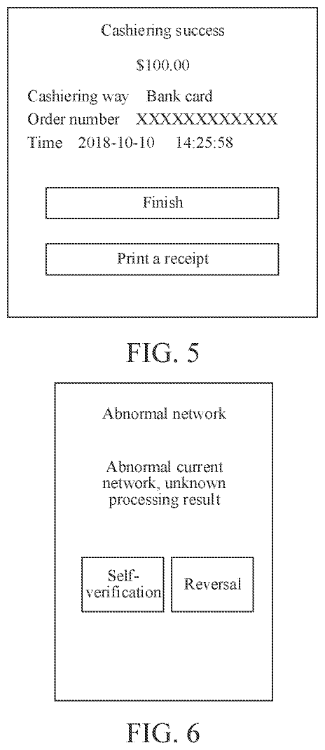

That is, if it is determined in step S404 that the order transaction is successful (which indicates that the order transaction processed by the server is successful), in this step, the payee terminal may display the transaction success page, for example, as shown in FIG. 5, display a cashiering success page. In this case, the payee terminal further supports to print a receipt representing a successful payment for retention.

Step S406. The payee terminal displays a transaction failure page.

If it is determined in step S404 that the order transaction fails (which indicates that the order transaction processed by the server fails), in this step, the payee terminal displays a transaction failure page.

Step S407. The payee terminal determines whether the transaction result is found; and performs step S404 if yes, and performs step S408 if not.

In practice, due to failure, network, or other reasons, the payee terminal may not find the transaction result. Therefore, after the query request is sent in step S403, in step S407, whether the transaction result is found is determined, and step S404 is performed in a case that the transaction result is found, that is, whether the order transaction is successful is determined, and a corresponding page is displayed according to whether the order transaction is successful. Step S408 is performed in a case that the transaction result is not found. It should be noted that, reducing transaction time and improving consumer's experience are considered. The payee terminal sets a query duration, for example, 30 seconds, that is, wait for the query result of the server within 30 seconds. If the query result of the server is not received within 30 seconds, alternatively, the query result of the server is that the transaction result is not found, the payee terminal determines that the transaction result is not found.

Step S408. The payee terminal displays a page that the result is unknown and a self-verification or a reversal is required.

The payee terminal displays a result unknown page if the transaction result is not found.

In an actual application, as shown in FIG. 6, after displaying the result unknown page, the payee terminal displays a self-verification option or a reversal option for triggering at the result unknown page. If the self-verification option is triggered, it indicates that the self-verification is performed and step S409 is performed; and if the reversal option is triggered, it indicates that the reversal is performed and step S413 is performed.

It should be noted that, the payee terminal determines to trigger a self-verification procedure or a reversal procedure according to whether the payer account already deducts the payment. For example, if the payer account already successfully deducts the payment, the self-verification option is triggered. In this way, a quantity of times of reversals can be reduced, thereby saving payer's time, and improving payer's satisfaction. The payee terminal triggers the reversal option to cancel this order transaction if the payer account does not successfully deduct the payment.

Step S409. The payee terminal sends a self-verification request.

After the self-verification option is triggered, the payee terminal provides an input interface of transaction verification information, and obtains the transaction verification information through the input interface, adds the transaction verification information into the self-verification request, and sends the self-verification request to a server, where the self-verification request includes the order information and the transaction verification information. After receiving the self-verification request, the server checks whether the transaction verification information matches the verification information of the order transaction; and returns a self-verification success message if the transaction verification information matches the verification information, and returns a self-verification failure message if the transaction verification information does not match the verification information.

Step S410. The payee terminal determines whether the self-verification is successful; performs step S411 if the self-verification is successful, and performs step S412 if the self-verification fails.

In this step, the payee terminal determines whether the self-verification is successful. For example, the payee terminal determines, in a case that the self-verification success message returned by the server is received, that the self-verification is successful; and determines, in a case that the self-verification failure message returned by the server is received, that the self-verification fails.

Step S411 is performed in a case that the self-verification is successful, and step S412 is performed in a case that the self-verification fails.

Step S411. The payee terminal displays a self-verification success page.

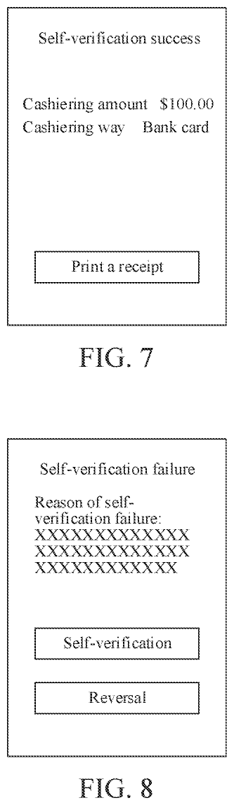

In this step, as shown in FIG. 7, the self-verification success page including self-verification success information is displayed for the merchant to view and learn in time that the order transaction is already successful. In an actual application, when displaying the self-verification success page, the payee terminal further supports to print a receipt representing a successful payment for retention.

Step S412. The payee terminal displays a self-verification failure page.

In this step, as shown in FIG. 8, the payee terminal displays a page including self-verification failure information for the merchant to view and learn in time that the order transaction fails.

The self-verification may failure due to an unfavorable network condition. Therefore, after step S412 is performed, the payee terminal can try to perform a self-verification again, that is, return to perform step S409 to initiate a self-verification request again. Alternatively, the payee terminal prompts the user to perform a reversal, and perform a new transaction after the reversal is completed.

Step S413. The payee terminal prompts to perform a reversal and perform a new transaction.

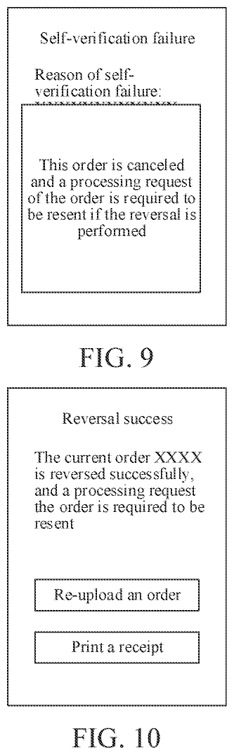

In this step, after the reversal option displayed by the payee terminal is triggered, to avoid a misoperation of a user, the payee terminal further provides a reversal pop-up prompt in this embodiment. As shown in FIG. 9, pop-up prompt content includes: if a reversal is performed, this order transaction is canceled and a new transaction processing request of an order transaction is required.

Optionally, the reversal procedure is to send a reversal request including the order information to the server, and the server determines after receiving the reversal request. The transaction result is canceled in a case that this order transaction is already performed, and the order transaction is not performed in a case that this order transaction is not performed. The reversal result is returned to the payee terminal. The canceling the transaction result means transferring the resources transferred during the order transaction process to the original account again.

Step S414. The payee terminal displays a reversal success page.

The payee terminal displays the reversal success page according to the reversal result for the user to view in time that the current reversal is successful and a new transaction can be performed, as shown in FIG. 10, the reversal success page includes a reversal success notification and a re-transaction option.

In an actual application and in this embodiment, after displaying the reversal success page, the payee terminal prompts to print a receipt used for representing a successful reversal for retention.

So far, the electronic transaction procedure in this embodiment is completed. Some steps (for example, steps corresponding to the self-verification procedure) in the procedures of the method shown in FIG. 4 can be omitted. Certainly, some steps can be added according to actual requirements. This is not limited herein.

The electronic transaction processing method shown in FIG. 4 changes a manner of automatic reversal triggering of the electronic transaction, that is, an automatic reversal procedure is changed into a manual reversal of the merchant, and a body that cancels the transaction is changed from the system to the merchant, to reduce the reversal rate. The reversal rate may be decreased greatly by applying the electronic transaction processing method according to this embodiment. In addition, the loss of funds caused by an automatic reversal in case of system failure is reduced.

It should be noted that for ease of description, the method embodiments are all described as a series of action combinations. However, a person skilled in the art should learn that the embodiments of the present disclosure are not limited by the described action sequence because some steps may be performed in other sequences or simultaneously according to the embodiments of the present disclosure. In addition, a person skilled in the art should also appreciate that all the embodiments described in the specification are optional embodiments, and the related actions are not necessarily mandatory to the actual implementation of the present disclosure.

### Embodiment 4

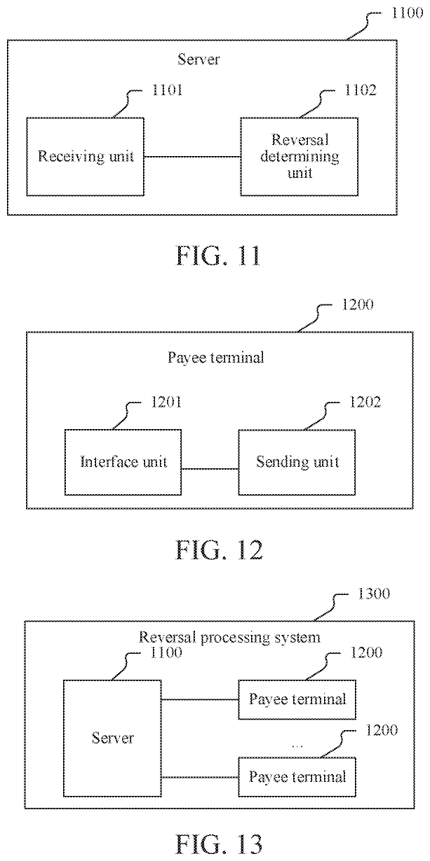

FIG. 11 is a structural block diagram of a server according to an embodiment of the present disclosure. Referring to FIG. 11, a server 1100 includes:

a receiving unit 1101, configured to receive a self-verification request sent by a payee terminal for an order transaction; and

a reversal determining unit 1102, configured to determine whether transaction verification information carried in the self-verification request matches verification information of the order transaction stored in the server, where the verification information of the order transaction is sent to an associated payer account when the order transaction processing is successful; and reversal processing is not carried out if the transaction verification information matches the verification information of the order transaction.

In an embodiment of the present disclosure, the reversal determining unit 1102 is further configured to carry out reversal processing if the transaction verification information carried in the self-verification request does not match the verification information of the order transaction.

In an embodiment of the present disclosure, the reversal determining unit 1102 is configured to determine whether the transaction verification information carried in the self-verification request is consistent with the verification information of the order transaction and whether the transaction verification information is valid; if the transaction verification information is consistent with the verification information of the order transaction and the transaction verification information is valid, determine that the transaction verification information matches the verification information of the order transaction, and determine, if the transaction verification information is not consistent with the verification information, or the transaction verification information is invalid, that the transaction verification information does not match the verification information of the order transaction.

In an embodiment of the present disclosure, the server 1100 further includes: a self-verification mark unit, configured to add a self-verification success mark for the order transaction if it is determined that the transaction verification information matches the verification information of the order transaction.

In an embodiment of the present disclosure, the server 1100 further includes: a query and processing unit, configured to query, if a query request including the order information sent by the payee terminal is received, a transaction result of an order transaction corresponding to the order information according to the query request, and return the transaction result to the payee terminal.

In an embodiment of the present disclosure, the carrying out reversal processing includes: determining a corresponding order transaction according to the order information included in the received reversal request sent by the payee terminal, canceling the order transaction, and adding a reversal mark for the canceled order transaction.

### Embodiment 5

FIG. 12 is a structural block diagram of a payee terminal according to an embodiment of the present disclosure. Referring to FIG. 12, a payee terminal 1200 includes:

an interface unit 1201, configured to send a transaction processing request including order information to the server; if the transaction result returned by the server for the transaction processing request is not received in a first target duration, provide an input interface of transaction verification information, obtain the transaction verification information through the input interface; and

a sending unit 1202, configured to add the obtained transaction verification information into a self-verification request; send the self-verification request to the server.

In an embodiment of the present disclosure, the interface unit 1201 is specifically configured to obtain transaction verification information in a deduction notification of an associated payer account through the input interface.

In an embodiment of the present disclosure, the payee terminal 1200 shown in FIG. 12 further includes: a prompt unit, configured to output prompt information of a successful transaction if a self-verification success message returned by the server is received; and output, if a self-verification failure message returned by the server is received, prompt information that the transaction fails and a reversal is performed.

In an embodiment of the present disclosure, the payee terminal 1200 shown in FIG. 12 further includes: a query unit, configured to send, in a case that the transaction result returned by the server is not received in a first target duration, a query request including the order information to the server, and notify, if a transaction result is still not found in a second target duration, the interface unit to perform the step of providing an input interface of transaction verification information.

In an embodiment of the present disclosure, the payee terminal 1200 shown in FIG. 12 further includes: a reversal request unit, configured to provide a reversal option in a case that the transaction result returned by the server is not received in the first target duration; and send, if the reversal option is triggered, a reversal request including the order information to the server.

### Embodiment 6

FIG. 13 is a structural block diagram of a reversal processing system according to an embodiment of the present disclosure. Referring to FIG. 13, a reversal processing system 1300 includes: a server 1100 and at least one payee terminal 1200 communicating with the server 1100.

The server 1100 includes a processor and a storage medium configured to store executable instructions of the processor, the processor being configured to execute instructions that correspond to steps of the electronic transaction processing method according to Embodiment 1 and that are stored in the storage medium.

The payee terminal 1200 includes a processor and a storage medium configured to store executable instructions of the processor, the processor being configured to execute instructions that correspond to steps of the electronic transaction processing method according to Embodiment 2 and that are stored in the storage medium.

In addition, the logic instructions in the storage medium may be stored in a computer-readable storage medium when implemented in a form of a software functional unit and sold or used as an independent product.

Based on such an understanding, the technical solutions of the present disclosure essentially, or the part contributing to the prior art, or some of the technical solutions can be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

An embodiment of the present disclosure provides a computer-readable storage medium, storing a computer program, the steps of the electronic transaction processing method according to Embodiment 1, Embodiment 2, or Embodiment 3 being implemented when the program is executed by a processor.

During application, besides rendering the payee terminal incapable of receiving the transaction result in time, the network failure and other failures between the payee terminal and the server may also render the payee terminal incapable of receiving the self-verification result in time. That is, even if the technical solution of canceling the automatic reversal is provided and the reversal rate is reduced by initiating a self-verification by the payee terminal, the reversal is still triggered due to the failure of receiving the self-verification result, and consequently, the reversal rate is kept high. According to statistics, approximately 45% of the self-verifications fail due to problems of communication between the payee terminal and the server of the platform when the payee terminal performs a self-verification.

In view of this, the embodiments of the present disclosure provide a solution for the payee terminal to perform a self-verification. In this way, the problem that the reversal rate is excessively high because the user selects to perform a reversal during a self-verification failure caused by the poor communication (for example, the payee terminal fails to receive a notification that the self-verification of the server is successful) between the payee terminal and the service end is fundamentally resolved. That is, if the self-verification request is sent to the server, the server determines whether the transaction verification information carried in the self-verification request matches the verification information of the order transaction according to the self-verification request, that is, the server determines whether the self-verification is valid. If the self-verification request is not sent to the server or the self-verification request is sent to the server but the self-verification result determined by the server is not successfully sent to the payee terminal, the self-verification is performed by the payee terminal.

### Embodiment 7

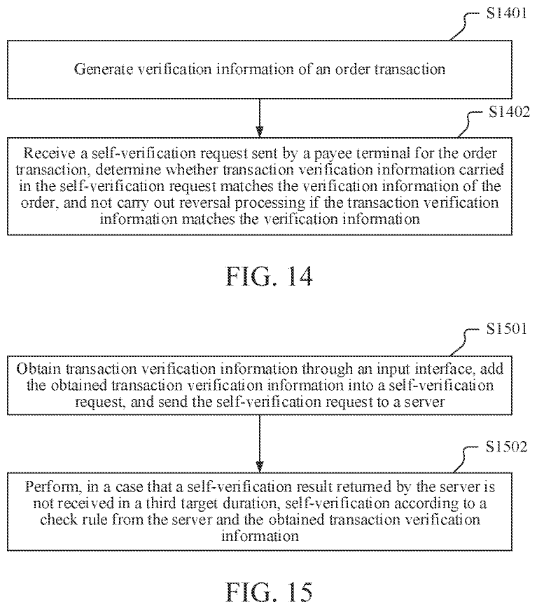

FIG. 14 is a flowchart of an electronic transaction processing method according to an embodiment of the present disclosure. Referring to FIG. 14, the electronic transaction processing method according to this embodiment of the present disclosure is applied to a server and includes the following steps.

Step S1401. A server generates verification information of an order transaction.

Step S1402. The server receives a self-verification request sent by a payee terminal for the order transaction, determines whether transaction verification information carried in the self-verification request matches the verification information of the order transaction, and does not carry out reversal processing if the transaction verification information matches the verification information. The verification information of the order transaction is sent to an associated payer account in a case that the order transaction processing is successful.

Optionally, generating verification information of an order in step S1401 includes: generating, if a transaction processing request of an order transaction sent by the payee terminal is received, verification information of the order transaction according to a daily check number and an encoding mode set for a target date; and sending, in a case that the order transaction processing is successful, the verification information of the order transaction to the associated payer account. Optionally, the order transaction is a bank card payment order transaction.

Considering that the single amount of the bank card payment order transaction is large, the fund loss caused by the wrong reversal is serious. Moreover, the problem of bank card cash out often occurs by using the network failure of both communication parties, and an example in which the order transaction is the bank card payment order transaction is used in this embodiment to describe steps for implementing the electronic transaction processing method. Optionally, the payee terminal in this embodiment is a POS machine.

In an embodiment, after receiving a transaction processing request of a bank card payment order transaction sent by a POS machine, the server generates verification information of the bank card payment order transaction according to a daily check number and an encoding mode set for a target date.

Optionally, the target date herein is a day on which the transaction processing request of the bank card payment order transaction is received. In this embodiment, the daily check number and the encoding mode change with the date, and the server generates the verification information of the order transaction according to the daily check number per day and the encoding mode per day. Optionally, the target date refers to a current day, a current month, a current quarter, a current year, or the like on which a transaction processing request of the bank card payment order transaction is received. The target date is not limited in this embodiment.

In this embodiment, the daily check number of the target date is a natural number between 16 and 128.

To ensure that the daily check number can be delivered to the POS machine in time, the server determines a natural number between 16 and 128 as the daily check number of a next day in advance, and stores the daily check number by using a date corresponding to the next day as a primary key correspondingly. For example, the server determines, at 23 o'clock on February 4, that the daily check number to be used on February 5 is 120, and stores the daily check number, namely, 120 and data information, namely, February 5 correspondingly.

The encoding mode set for the target date is an encoding mode for encoding characters in a designated character set on the target date. The designated character set is a character set including 10 numbers from 0 to 9 and 26 English letters from A to Z.

Optionally, the encoding characters in a designated character set includes: performing, according to the encoding mode corresponding to the target date, binary Huffman coding on the characters in the designated character set, to enable an average value of encoding lengths of the encoded characters to be within a threshold range, where the threshold range is determined by the daily check number of the target date. In an embodiment, the threshold range determined by the daily check number of the target date is a limited range from [(daily check number/6)+4] to [(daily check number/6)−4], and the symbol “/” represents division in the arithmetical operation. That is, the changes of the encoding mode and the daily check number of the character not only happen every day, but also correlate with each other. In an embodiment of the present disclosure, the verification information of the bank card payment order transaction is a six-digit verification code composed of letters and numbers, for example, 68MK2W. The verification information of the bank card payment order transaction is sent to an associated payer account in a case that the transaction is successful. Optionally, after generating the six-digit verification code, the server sends the six-digit verification code to a bank server corresponding to the bank card, and when the bank server deducts from a bank account of the payer and sends a deduction notification, the six-digit verification code is added into the deduction notification to be sent to the associated payer account. It may be understood that, the bank server sends the deduction notification in a manner of a short message service message or a transaction record, and this is not limited in this embodiment of the present disclosure.

It should be noted that, compared with the mobile payment (for example, a resource transfer APP, a shopping APP, or the like) based on Internet application, the bank card payment has its particularity, that is, the bank card payment needs to follow the 8583 packet protocol of the International Organization for Standardization (ISO) international standard packet format. The 8583 packet is composed of 128 fields at most, each field has a uniform specification, and there is a fixed length and a variable length. According to UnionPay regulations, before performing the first transaction each day, the POS machine needs to initiate a sign-in request to the server to enable the server to return three working keys, which are respectively used for encrypting three pieces of information of the bank card transmitted from the POS machine to the server, to enhance the security.

Based on this, according to this embodiment of the present disclosure, after determining the daily check number of the day and the encoding mode of the day, the server sends, when the POS machine signs in each day, that is, after the server receives the sign-in packet sent by the payee terminal on the day, the determined daily check number of the day and the determined encoding mode of the day to the payee terminal. After the server sends the check rule, that is, the daily check number and the encoding mode, to the POS machine, the POS machine performs self-verification on the obtained transaction verification information according to the two items of information. The procedure of the self-verification of the client is described below.

It can be learned from the foregoing that, in this embodiment of the present disclosure, the server delivers the check rule to the payee terminal, so that the payee terminal completes the self-verification (the self-verification means that the payer proves to the server through the payee terminal that a transaction is already successfully deducted) in a case of poor network, a quantity of times that the payee terminal initiates a reversal is reduced, which is beneficial to reducing the reversal rate. In addition, a possibility that the server is attacked is also reduced by delivering the check rule of the day each day by the server, thereby ensuring the credibility of the self-verification of the payee terminal.

To further ensure that there is no fund loss of the platform caused by an attack or a cheat of the payee terminal during the self-verification, a secondary verification of the server is also provided in this embodiment of the present disclosure.

For example, the server receives a transaction processing request of an order transaction sent by the payee terminal, the transaction processing request including transaction verification information and order information of a bank card payment order transaction whose occurrence time is earlier than that of the order transaction and whose self-verification is successful; and verifies the self-verification validity of the bank card payment order transaction whose self-verification is successful.

After receiving a transaction processing request of an order transaction sent by the payee terminal, if it is determined that the transaction processing request includes transaction verification information and order information of a bank card payment order transaction whose occurrence time is earlier than that of the order transaction and whose self-verification is successful, the server verifies the self-verification validity of the bank card payment order transaction whose self-verification is successful.

It should be noted that, most POS machines have limited storage space, and therefore, when a POS machine sends a transaction processing request of an order transaction, if a self-verification of a bank card payment order transaction whose occurrence time is earlier than that of the order transaction is successful, the POS machine carries transaction verification information and order information corresponding to the bank card payment order transaction whose self-verification is successful into the transaction processing request corresponding to the order transaction and sends the transaction processing request to the server. It may be understood that, the occurrence time of the bank card payment order transaction whose self-verification is successful is earlier than that of another order transaction corresponding to the transaction processing request, and the two order transactions are only in chronological order.

In an embodiment of the present disclosure, verifying the self-verification validity of the bank card payment order transaction whose self-verification is successful includes: restoring, according to the encoding mode of the target date, characters in the transaction verification information to corresponding binary Huffman codes, and calculating a sum of lengths of the binary Huffman codes corresponding to the characters in the transaction verification information to obtain a calculation result; and determining whether the calculation result is equal to the daily check number of the target date; and determining that the self-verification is valid in a case that the calculation result is equal to the daily check number, and determining that the self-verification is invalid in a case that the calculation result is not equal to the daily check number.

The server generates the verification information (the verification code) of the order transaction according to the encoding mode of the target date and the daily check number of the target date, that is, generates the verification code in a manner of enabling the sum of the lengths of the binary Huffman codes corresponding to the encoded characters to be equal to the daily check number and sends the verification code to an associated payer account through the bank server. Therefore, if the transaction verification information provided by the payer or obtained by the POS machine is not attacked, the sum of the lengths of the binary Huffman codes of the characters in the transaction verification information that can be restored by the server according to an inverse operation of generating the verification information of the order transaction is definitely equal to the daily check number. Based on the foregoing principles, after receiving the transaction verification information of the bank card payment order transaction whose self-verification is successful, the server restores, according to the encoding mode of the target date, characters in the transaction verification information to corresponding binary Huffman codes, and calculates a sum of lengths of the binary Huffman codes corresponding to the characters in the transaction verification information, to obtain a calculation result; and determines whether the calculation result is equal to the daily check number of the target date; and determines that the self-verification is valid in a case that the calculation result is equal to the daily check number, and determines that the self-verification is invalid in a case that the calculation result is not equal to the daily check number.

It can be learned from the foregoing that, the verification code of the bank card payment order transaction whose self-verification is successful is finally sent by the payee terminal to the server for a secondary verification and a mark. In this way, the fund loss of the platform caused by suspicious transactions and other attacks is avoided.

### Embodiment 8

FIG. 15 is a schematic flowchart of an electronic transaction processing method according to another embodiment of the present disclosure. Referring to FIG. 15, the electronic transaction processing method according to this embodiment is applied to a payee terminal and includes the following steps.

Step S1501. Obtain transaction verification information through an input interface, add the obtained transaction verification information into a self-verification request, and send the self-verification request to a server.

Step S1502. Perform, in a case that a self-verification result returned by the server is not received in a third target duration, self-verification according to a check rule from the server and the obtained transaction verification information.

It should be noted that, in this embodiment, the payee terminal (for example, a POS machine) provides an input interface and obtains the transaction verification information through the input interface, and adds the obtained transaction verification information into a self-verification request, and sends the self-verification request to the server. Considering that the network between a POS machine and a server may be poor in practice, and the POS machine may probably fail to receive information from the server for a long time, to prevent the reversal rate from being excessively high due to active initiation of a reversal by the POS machine in a case of a poor network, in this embodiment, a timer is set for the server to return the self-verification result. If a time recorded by the timer reaches the third target duration (for example, 60 seconds), the POS machine performs the self-verification according to the check rule from the server and the obtained transaction verification information. In this way, on the one hand, by setting the duration threshold, the payee terminal is triggered to perform the self-verification only when the self-verification result is not received in the third target duration, which prevents the payee terminal from performing a large quantity of self-verifications, so that overheads of the POS machine are prevented from increasing. On the other hand, a solution of performing a self-verification is provided for the payee terminal when the self-verification result of the server is not received, which avoids problems affecting the payer's experience such as the consumers need to wait for a long time when the network is poor, and helps better deal with complex situations of the transaction spot.

In an embodiment of the present disclosure, the check rule from the server includes: an encoding mode and a daily check number corresponding to the target date. The encoding mode corresponding to the target date is an encoding mode for encoding characters in a designated character set on the target date, where an average value of encoding lengths of the encoded characters is within a threshold range determined by the daily check number of the target date. The threshold range determined by the daily check number corresponding to the target date is a limited range from [(daily check number/6)+4] to [(daily check number/6)-4], and the symbol “/” represents division in the arithmetical operation. Huffman coding, also referred to as Huffman encoding, is an encoding manner, and the Huffman coding is one type of variable length coding. In this embodiment, the daily check number corresponding to the target date is a natural number between 16 and 128.

Obtaining transaction verification information through an input interface in the foregoing step S1501 includes: obtaining transaction verification information of a bank card payment order transaction generated by the server according to the encoding mode and the daily check number of the target date through the input interface. The obtained transaction verification information is, for example, a six-digit verification code 68MK2W composed of letters and numbers.

In an embodiment of the present disclosure, performing the self-verification according to the check rule from the server and the obtained transaction verification information includes: restoring, according to the encoding mode of the target date, characters in the obtained transaction verification information to corresponding binary Huffman codes, and obtaining a sum of lengths of the binary Huffman codes corresponding to the characters in the transaction verification information to obtain a length result; and determining whether the length result is equal to the daily check number of the target date; and determining that the self-verification is successful in a case that the calculation result is equal to the daily check number, and determining that the self-verification fails in a case that the calculation result is not equal to the daily check number.

It should be noted that, according to the regulations, the POS machine supporting a bank card payment follows the 8583 protocol, and the POS machine first sends a sign-in packet to the server after starting up every day. In this case, the server delivers a daily check number of the day and an encoding mode of the day to the POS machine according to the received sign-in packet, and subsequently the POS machine performs the self-verification according to the daily check number of the day and the encoding mode of the day, thereby reducing the probability of being attacked. Optionally, a self-verification procedure is as follows: the POS machine restores, according to the encoding mode of the day, the characters in the transaction verification information (the transaction verification information is from the associated payer account) obtained through the input interface to corresponding binary Huffman codes, then calculates a sum of lengths of the binary Huffman codes corresponding to the characters to obtain a calculation result (for example, the sum is 120); and determines whether the calculation result (120) is equal to the daily check number (120) of the day, and determines that the self-verification is successful in a case that the calculation result is equal to the daily check number, and determines that the self-verification fails in a case that the calculation result is not equal to the daily check number. It can be learned that, the calculation result and the daily check number in this embodiment are both 120, which are equal.

The POS machine outputs prompt information in a case that the self-verification is successful or fails, which helps the user learn of the result of the self-verification in time.

In an embodiment of the present disclosure, the electronic order transaction processing method further includes: adding, after it is determined that the self-verification is successful, the transaction verification information and the order information corresponding to the bank card payment order transaction into a transaction processing request of another order transaction, and uploading the transaction processing request to the server, for the server to verify the self-verification validity of the bank card payment order transaction whose self-verification is successful. An occurrence time of the another order transaction is later than that of the order transaction whose self-verification is successful.

Considering that most POS machines have limited storage space, optionally, the POS machine in this embodiment only stores data of one bank card payment order transaction whose self-verification is successful to save the storage space. In this way, each time the POS machine performs a next order transaction after the bank card payment order transaction and needs to send a transaction processing request corresponding to the next order transaction to the server, the POS machine adds transaction verification information and order information of a bank card payment order transaction whose occurrence time is earlier than that of the next order transaction and whose self-verification is successful into the transaction processing request corresponding to the next order transaction, and sends the transaction processing request to the server, to enable the server to verify the self-verification validity of the bank card payment order transaction whose self-verification is successful according to the transaction verification information of the bank card payment order transaction.

It can be learned from the foregoing that, in this embodiment, the payee terminal receives the check rule from the server, and performs verification on the transaction verification information according to the obtained transaction verification information and the check rule from the server in a case that the network communication between the payee terminal and the server is poor, to prevent the payer's experience from being affected by waiting for a long time, and also resolve the problem of an excessively high reversal rate caused by selection of a reversal when the self-verification fails.

### Embodiment 9

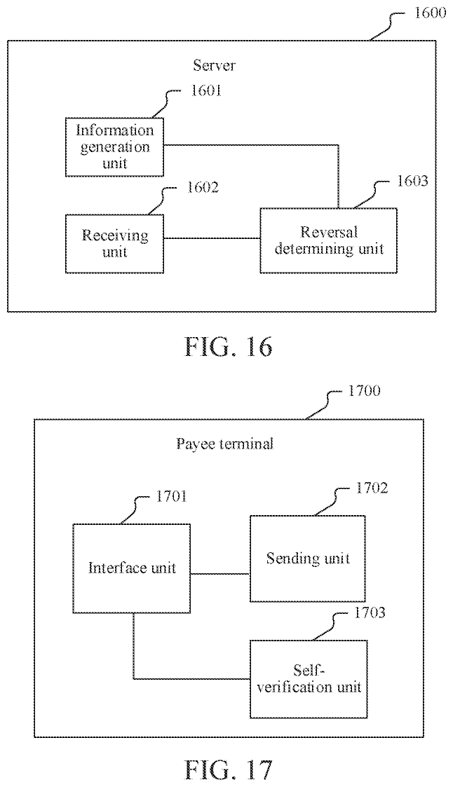

FIG. 16 is a block diagram of a server according to an embodiment of the present disclosure. Referring to FIG. 16, a server 1600 in this embodiment includes an information generation unit 1601, a receiving unit 1602, and a reversal determining unit 1603.

The information generation unit 1601 is configured to generate verification information of an order transaction.

The receiving unit 1602 is configured to receive a self-verification request sent by a payee terminal for the order transaction.

The reversal determining unit 1603 is configured to determine whether transaction verification information carried in the self-verification request matches the verification information of the order transaction, and reversal processing is not carried out if the transaction verification information matches the verification information of the order transaction. The verification information of the order transaction is sent to an associated payer account in a case that the order transaction is successful.

In an embodiment of the present disclosure, the information generation unit 1601 is configured to generate, if a transaction processing request of a bank card payment order transaction sent by the payee terminal is received, verification information of the bank card payment order transaction according to a daily check number and an encoding mode set for a target date; and send, in a case that the order transaction is successful, the verification information of the bank card payment order transaction to the associated payer account.

In an embodiment of the present disclosure, the daily check number is a natural number between 16 and 128, and the encoding mode is an encoding mode for encoding characters in a designated character set on the target date. The encoding characters in a designated character set on the target date includes: performing, according to the encoding mode corresponding to the target date, binary Huffman coding on the characters in the designated character set, to enable an average value of encoding lengths of the encoded characters to be within a threshold range determined by the daily check number of the target date.

In an embodiment of the present disclosure, the server further includes a delivering unit, configured to send, if a sign-in packet sent by the payee terminal on the target date is received, the daily check number and the encoding mode corresponding to the target date to the payee terminal.

In an embodiment of the present disclosure, the server further includes a secondary verification unit, configured to receive a transaction processing request of an order transaction sent by the payee terminal, the transaction processing request including transaction verification information and order information of a bank card payment order transaction whose occurrence time is earlier than that of the order transaction and whose self-verification is successful; and verify the self-verification validity of the bank card payment order transaction whose self-verification is successful. Verifying the self-verification validity of the bank card payment order transaction whose self-verification is successful includes: restoring, according to the encoding mode corresponding to the target date, characters in the transaction verification information to corresponding binary Huffman codes, and calculating a sum of lengths of the binary Huffman codes corresponding to the characters in the transaction verification information to obtain a calculation result; and determining whether the calculation result is equal to the daily check number of the target date; and determining that the self-verification is valid in a case that the calculation result is equal to the daily check number, and determining that the self-verification is invalid in a case that the calculation result is not equal to the daily check number.

It should be noted that, a working procedure of a functional unit of the server in this embodiment is consistent with the illustration and description of the example in the method embodiment of Embodiment 7. This is not repeated herein.

### Embodiment 10

FIG. 17 is a block diagram of a payee terminal according to an embodiment of the present disclosure. Referring to FIG. 17, a payee terminal 1700 in this embodiment includes an interface unit 1701, a sending unit 1702, and a self-verification unit 1703.

The interface unit 1701 is configured to obtain transaction verification information through an input interface.

The sending unit 1702 is configured to add the obtained transaction verification information into a self-verification request, and send the self-verification request to a server.

The self-verification unit 1703 is configured to perform, in a case that a self-verification result returned by the server is not received in a third target duration, self-verification according to a check rule from the server and the obtained transaction verification information.

In an embodiment of the present disclosure, the check rule from the server includes: an encoding mode and a daily check number corresponding to the target date; the encoding mode corresponding to the target date is an encoding mode for encoding characters in a designated character set on the target date, to enable an average value of encoding lengths of the encoded characters to be within a threshold range determined by the daily check number of the target date; and the daily check number of the target date is a natural number between 16 and 128.

The interface unit 1701 is configured to obtain transaction verification information of a bank card payment order transaction generated by the server according to the encoding mode and the daily check number of the target date through the input interface.

In an embodiment of the present disclosure, the self-verification unit 1703 is configured to restore, according to the encoding mode of the target date, characters in the obtained transaction verification information to corresponding binary Huffman codes, and calculate a sum of lengths of the binary Huffman codes corresponding to the characters in the transaction verification information to obtain a calculation result; and determine whether the calculation result is equal to the daily check number of the target date; and determine that the self-verification is successful in a case that the calculation result is equal to the daily check number, and determine that the self-verification fails in a case that the calculation result is not equal to the daily check number.

In an embodiment of the present disclosure, the sending unit 1702 is further configured to add, after it is determined that the self-verification is successful, the transaction verification information and the order information corresponding to the bank card payment order transaction into a transaction processing request of another order transaction whose time is later than that of the bank card payment order transaction, and upload the transaction processing request to the server, for the server to verify the self-verification validity of the bank card payment order transaction whose self-verification is successful.

It should be noted that, a working procedure of a functional unit of the payee terminal in this embodiment is consistent with the illustration and description of the example in the method embodiment of Embodiment 8. This is not repeated herein.

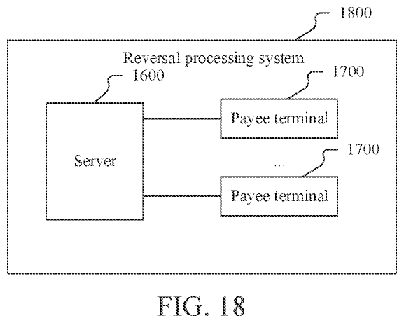

FIG. 18 is a block diagram of a reversal processing system according to an embodiment of the present disclosure. Referring to FIG. 18, a reversal processing system 1800 includes: a server 1600 and at least one payee terminal 1700 communicating with the server 1600.

The server 1600 includes a processor and a storage medium configured to store executable instructions of the processor, the processor being configured to execute instructions that correspond to steps of the electronic transaction processing method according to Embodiment 7 and that are stored in a memory.

The payee terminal 1700 includes a processor and a storage medium configured to store executable instructions of the processor, the processor being configured to execute instructions that correspond to steps of the electronic transaction processing method according to Embodiment 8 and that are stored in the storage medium.

An embodiment of the present disclosure further provides a computer-readable storage medium, storing a computer program, the steps of the electronic transaction processing method according to Embodiment 7 or Embodiment 8 being implemented when the program is executed by a processor.

A person skilled in the art should understand that the embodiments of the present disclosure may be provided as a method, a system, or a computer program product. Therefore, the present disclosure may use a form of hardware-only embodiments, software-only embodiments, or embodiments combining software and hardware. In addition, the present disclosure may use a form of a computer program product implemented on one or more computer available storage media (including but not limited to a disk memory, a CD-ROM, an optical memory, and the like) including computer available program code.

An embodiment of the present disclosure provides a terminal. Optionally, the terminal is a payer terminal, for example, a mobile phone, a tablet computer, a Moving Picture Experts Group Audio Layer III (MP3) player, a Moving Picture Experts Group Audio Layer IV (MP4) player, a notebook computer or a desktop computer. The terminal may also be referred to other names such as a user device, a portable terminal, a laptop terminal, or a desktop terminal. Optionally, the terminal is a payee terminal, for example, a POS machine.

The terminal includes a processor and a memory.

The processor includes one or more processing cores, for example, may be a 4-core processor or an 8-core processor. The processor may be implemented by using at least one hardware form of digital signal processing (DSP), a field-programmable gate array (FPGA), and a programmable logic array (PLA). The processor may alternatively include a main processor and a coprocessor. The main processor is a processor configured to process data in an awake state, also referred to as a central processing unit (CPU), and the coprocessor is a low-power processor configured to process data in an idle state. In some embodiments, the processor may be integrated with a graphics processing unit (GPU). The GPU is configured to be responsible for rendering and drawing content that a display needs to display.

The memory may include one or more computer-readable storage media. The computer-readable storage medium may be non-transient. The memory may further include a high-speed random access memory and a non-volatile memory, such as one or more magnetic disk storage devices or flash storage devices. In some embodiments, the non-transitory computer-readable storage medium in the memory is configured to store at least one program code, and the at least one program code being configured to be executed by the processor to implement the electronic transaction processing method provided in the method embodiments of the present disclosure.

In some embodiments, the terminal further optionally includes a peripheral interface and at least one peripheral. The processor, the memory, and the peripheral interface may be connected by a bus or a signal cable. Each peripheral may be connected to the peripheral interface by using a bus, a signal cable, or a circuit board. Optionally, the peripheral includes: at least one of a radio frequency (RF) circuit, a display screen, a camera, an audio circuit, and a power supply.

A person skilled in the art may understand that the terminal may further include more or fewer components, or some components may be combined, or a different component deployment may be used.

An embodiment of the present disclosure further provides a server. The server may vary a lot due to different configurations or performance, and may include one or more CPUs and one or more memories. The memory stores at least one program code, the at least one program code being loaded and executed by the processor to implement the method provided in the foregoing method embodiments. Certainly, the server may further include components such as a wired or wireless network interface, a keyboard, and an input/output interface, to facilitate inputs/outputs. The server may further include another component configured to implement functions of a device, and details are not described herein again.

The server may be configured to perform the steps performed by the server in the foregoing electronic transaction processing method.

An embodiment provides a server, including a processor and a storage medium configured to store executable instructions of the processor. The processor is configured to execute the instructions stored in the storage medium, to implement the following steps: receiving a self-verification request sent by a payee terminal for an order transaction; determining whether transaction verification information carried in the self-verification request matches verification information of the order transaction stored in the server, where the verification information of the order transaction is sent to an associated payer account when the order transaction is successful; and not carrying out reversal processing if the transaction verification information matches the verification information of the order transaction.

In an embodiment of the present disclosure, the processor is configured to execute the instructions stored in the storage medium, to implement the following step: carrying out reversal processing if the transaction verification information carried in the self-verification request does not match the verification information of the order transaction.

In an embodiment of the present disclosure, the processor is configured to execute the instructions stored in the storage medium, to implement the following steps: determining whether the transaction verification information is consistent with the verification information and whether the transaction verification information is valid; determining, if the transaction verification information is consistent with the verification information and the transaction verification information is valid, that the transaction verification information matches the verification information; and determining, if the transaction verification information is not consistent with the verification information or the transaction verification information is invalid, that the transaction verification information does not match the verification information.

In an embodiment of the present disclosure, the processor is configured to execute the instructions stored in the storage medium, to implement the following step: adding a self-verification success mark for the order transaction if the transaction verification information matches the verification information of the order transaction.

In an embodiment of the present disclosure, the processor is configured to execute the instructions stored in the storage medium, to implement the following steps: receiving a query request that includes order information and that is sent by the payee terminal; querying a transaction result of an order transaction corresponding to the order information according to the query request; and returning the transaction result to the payee terminal.

In an embodiment of the present disclosure, the processor is configured to execute the instructions stored in the storage medium, to implement the following steps: receiving a transaction processing request sent by the payee terminal for the order transaction, and generating the verification information of the order transaction.

In an embodiment of the present disclosure, the processor is configured to execute the instructions stored in the storage medium, to implement the following steps: generating, if the transaction processing request is received, the verification information according to a daily check number and an encoding mode set for a target date; and sending, in a case that the order transaction is successful, the verification information to the associated payer account.

In an embodiment of the present disclosure, the daily check number is a natural number between 16 and 128, and the encoding mode is an encoding mode for encoding characters in a designated character set on the target date.

In an embodiment of the present disclosure, the processor is configured to execute the instructions stored in the storage medium, to implement the following steps: performing, according to the encoding mode corresponding to the target date, binary Huffman coding on the characters in the designated character set, to enable an average value of encoding lengths of the encoded characters to be within a threshold range, where the threshold range is determined by the daily check number of the target date.

In an embodiment of the present disclosure, the processor is configured to execute the instructions stored in the storage medium, to implement the following steps: receiving a sign-in packet sent by the payee terminal at the target date, and sending the daily check number and the encoding mode corresponding to the target date to the payee terminal.

In an embodiment of the present disclosure, the received transaction processing request further includes transaction verification information and order information of another order transaction, and an occurrence time of the another order transaction is earlier than that of the order transaction, and a self-verification of the another order transaction is already successful at the payee terminal. The processor is configured to execute the instructions stored in the storage medium, to implement the following step: verifying the self-verification validity of the another order transaction.

In an embodiment of the present disclosure, the processor is configured to execute the instructions stored in the storage medium, to implement the following steps: restoring, according to the encoding mode corresponding to the target date, characters in the transaction verification information of the another order transaction to corresponding binary Huffman codes, and calculating a sum of lengths of the binary Huffman codes corresponding to the characters in the transaction verification information to obtain a calculation result; and determining whether the calculation result is equal to the daily check number corresponding to the target date; and determining that the self-verification is valid in a case that the calculation result is equal to the daily check number, and determining that the self-verification is invalid in a case that the calculation result is not equal to the daily check number.

In an embodiment of the present disclosure, a payee terminal is provided. The payee terminal includes a processor and a storage medium configured to store executable instructions of the processor. The processor is configured to execute the instructions stored in the storage medium, to implement the following steps: sending a transaction processing request including order information to a server; providing, in a case that a transaction result returned by the server for the transaction processing request is not received in a first target duration, an input interface of transaction verification information, and obtaining transaction verification information through the input interface; adding the obtained transaction verification information into a self-verification request; and sending the self-verification request to the server.

In an embodiment of the present disclosure, the processor is configured to execute the instructions stored in the storage medium, to implement the following step: obtaining transaction verification information in a deduction notification of an associated payer account through the input interface.

In an embodiment of the present disclosure, the processor is configured to execute the instructions stored in the storage medium, to implement the following steps: outputting prompt information of a successful order transaction if a self-verification success message returned by the server is received; and outputting, if a self-verification failure message returned by the server is received, prompt information that the transaction fails and a reversal is performed.

In an embodiment of the present disclosure, the processor is configured to execute the instructions stored in the storage medium, to implement the following steps: performing, in a case that the transaction result returned by the server is not received in the first target duration and before the step of obtaining the transaction verification information is performed, any one of the following steps:

sending a query request including the order information to the server, and performing, in a case that a transaction result is still not found in a second target duration, the step of

providing an input interface of transaction verification information; and providing a reversal option, and sending a reversal request including the order information to the server if the reversal option is triggered.

In an embodiment of the present disclosure, the processor is configured to execute the instructions stored in the storage medium, to implement the following step: performing, in a case that a self-verification result returned by the server is not received in a third target duration, self-verification according to a check rule from the server and the obtained transaction verification information.

In an embodiment of the present disclosure, the check rule from the server includes: an encoding mode and a daily check number corresponding to the target date; the encoding mode is an encoding mode for encoding characters in a designated character set on the target date, where an average value of encoding lengths of the encoded characters is within a threshold range, and the threshold range is determined by the daily check number of the target date; and the daily check number of the target date is a natural number between 16 and 128. The transaction verification information is generated through the server according to the encoding mode and the daily check number of the target date.

In an embodiment of the present disclosure, the processor is configured to execute the instructions stored in the storage medium, to implement the following steps: restoring, according to the encoding mode of the target date, characters in the obtained transaction verification information to corresponding binary Huffman codes, and calculating a sum of lengths of the binary Huffman codes corresponding to the characters in the transaction verification information to obtain a calculation result; and determining whether the calculation result is equal to the daily check number of the target date; and determining that the self-verification is successful in a case that the calculation result is equal to the daily check number, and determining that the self-verification fails in a case that the calculation result is not equal to the daily check number.

In an embodiment of the present disclosure, the processor is configured to execute the instructions stored in the storage medium, to implement the following steps: adding transaction verification information and order information corresponding to an order transaction whose self-verification is successful into a transaction processing request of another order transaction and uploading the transaction processing request to a server for the server to verify self-verification validity of the order transaction whose self-verification is successful, where an occurrence time of the another order transaction is later than that of the order transaction whose self-verification is successful.

In an embodiment of the present disclosure, a computer-readable storage medium is further provided, storing a computer program. The program, when executed by a processor, implements the following steps: receiving a self-verification request sent by a payee terminal for an order transaction; determining whether transaction verification information carried in the self-verification request matches verification information of the order transaction stored in the server, where the verification information of the order transaction is stored to the server and sent to an associated payer account when the order transaction is successful; and not carrying out reversal processing if the transaction verification information matches the verification information of the order transaction.

In an embodiment of the present disclosure, the program, when executed by the processor, implements the following step: carrying out reversal processing if the transaction verification information carried in the self-verification request does not match the verification information of the order transaction.

In an embodiment of the present disclosure, the program, when executed by the processor, implements the following steps: determining whether the transaction verification information is consistent with the verification information and whether the transaction verification information is valid; determining, if the transaction verification information is consistent with the verification information and the transaction verification information is valid, that the transaction verification information matches the verification information; and determining, if the transaction verification information is not consistent with the verification information or the transaction verification information is invalid, that the transaction verification information does not match the verification information.

In an embodiment of the present disclosure, the program, when executed by the processor, implements the following step: adding a self-verification success mark for the order transaction if the transaction verification information matches the verification information of the order transaction.

In an embodiment of the present disclosure, the program, when executed by the processor, implements the following steps: receiving a query request that includes order information and that is sent by the payee terminal; querying a transaction result of an order transaction corresponding to the order information according to the query request; and returning the transaction result to the payee terminal.

In an embodiment of the present disclosure, the program, when executed by the processor, implements the following steps: receiving a transaction processing request sent by the payee terminal for the order transaction, and generating the verification information of the order transaction.

In an embodiment of the present disclosure, the program, when executed by the processor, implements the following steps: generating, if the transaction processing request is received, the verification information according to a daily check number and an encoding mode set for a target date; and sending, in a case that the order transaction is successful, the verification information to the associated payer account.

In an embodiment of the present disclosure, the daily check number is a natural number between 16 and 128, and the encoding mode is an encoding mode for encoding characters in a designated character set on the target date.

In an embodiment of the present disclosure, the program, when executed by the processor, implements the following steps: performing, according to the encoding mode corresponding to the target date, binary Huffman coding on the characters in the designated character set, to enable an average value of encoding lengths of the encoded characters to be within a threshold range, where the threshold range is determined by the daily check number of the target date.

In an embodiment of the present disclosure, the program, when executed by the processor, implements the following steps: receiving a sign-in packet sent by the payee terminal at the target date, and sending the daily check number and the encoding mode corresponding to the target date to the payee terminal.

In an embodiment of the present disclosure, the received transaction processing request further includes transaction verification information and order information of another order transaction, and an occurrence time of the another order transaction is earlier than that of the order transaction, and a self-verification of the another order transaction is already successful at the payee terminal. The processor is configured to execute the instructions stored in the storage medium, to implement the following step: verifying the self-verification validity of the another order transaction.

In an embodiment of the present disclosure, the program, when executed by the processor, implements the following steps: restoring, according to the encoding mode corresponding to the target date, characters in the transaction verification information of the another order transaction to corresponding binary Huffman codes, and calculating a sum of lengths of the binary Huffman codes corresponding to the characters in the transaction verification information to obtain a calculation result; and determining whether the calculation result is equal to the daily check number corresponding to the target date; and determining that the self-verification is valid in a case that the calculation result is equal to the daily check number, and determining that the self-verification is invalid in a case that the calculation result is not equal to the daily check number.

In an embodiment of the present disclosure, a computer-readable storage medium is further provided, storing a computer program. The program, when executed by a processor, implements the following steps: sending a transaction processing request including order information to a server; providing, in a case that a transaction result returned by the server for the transaction processing request is not received in a first target duration, an input interface of transaction verification information, and obtaining transaction verification information through the input interface; adding the obtained transaction verification information into a self-verification request; and sending the self-verification request to the server.

In an embodiment of the present disclosure, the program, when executed by the processor, implements the following step: obtaining transaction verification information in a deduction notification of an associated payer account through the input interface.

In an embodiment of the present disclosure, the program, when executed by the processor, implements the following steps: outputting prompt information of a successful order transaction if a self-verification success message returned by the server is received; and outputting, if a self-verification failure message returned by the server is received, prompt information that the transaction fails and a reversal is performed.

In an embodiment of the present disclosure, the program, when executed by the processor, implements the following steps: performing, in a case that the transaction result returned by the server is not received in the first target duration and before the step of obtaining the transaction verification information is performed, any one of the following steps:

sending a query request including the order information to the server, and performing, in a case that a transaction result is still not found in a second target duration, the step of providing an input interface of transaction verification information; and

providing a reversal option, and sending a reversal request including the order information to the server if the reversal option is triggered.

In an embodiment of the present disclosure, the program, when executed by the processor, implements the following step: performing, in a case that a self-verification result returned by the server is not received in a third target duration, self-verification according to a check rule from the server and the obtained transaction verification information.

In an embodiment of the present disclosure, the check rule from the server includes: an encoding mode and a daily check number corresponding to the target date; the encoding mode is an encoding mode for encoding characters in a designated character set on the target date, where an average value of encoding lengths of the encoded characters is within a threshold range, and the threshold range is determined by the daily check number of the target date; and the daily check number of the target date is a natural number between 16 and 128. The transaction verification information is generated through the server according to the encoding mode and the daily check number of the target date.

In an embodiment of the present disclosure, the program, when executed by the processor, implements the following steps: restoring, according to the encoding mode of the target date, characters in the obtained transaction verification information to corresponding binary Huffman codes, and calculating a sum of lengths of the binary Huffman codes corresponding to the characters in the transaction verification information to obtain a calculation result; and determining whether the calculation result is equal to the daily check number of the target date; and determining that the self-verification is successful in a case that the calculation result is equal to the daily check number, and determining that the self-verification fails in a case that the calculation result is not equal to the daily check number.

In an embodiment of the present disclosure, the program, when executed by the processor, implements the following steps: adding transaction verification information and order information corresponding to an order transaction whose self-verification is successful into a transaction processing request of another order transaction and uploading the transaction processing request to a server for the server to verify self-verification validity of the order transaction whose self-verification is successful, where an occurrence time of the another order transaction is later than that of the order transaction whose self-verification is successful.

The present disclosure is described with reference to flowcharts and/or block diagrams of the method, device (system), and computer program product in the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

The terms “include”, “comprise” and any other forms thereof mean to cover the non-exclusive inclusion. Thereby, the process, method, article, or device which includes a series of elements not only includes those elements, but also includes other elements which are not clearly listed, or further includes the inherent elements of the process, method, article or device. Unless otherwise specified, an element limited by “include a/an . . . ” does not exclude other same elements existing in the process, the method, the article, or the device that includes the element.

Lots of specific details are described in the specification of the present disclosure. However, it can be understood that the embodiments of the present disclosure may be implemented in a case without these specific details. In some examples, known methods, structures, and technologies are not disclosed in detail, so as not to mix up understanding on the specification. Similarly, it should be understood that to simplify the present disclosure and to help understand one or more of disclosure aspects, in the foregoing descriptions of the exemplary embodiments of the present disclosure, features of the present disclosure are sometimes grouped into a single embodiment or figure, or descriptions thereof. However, the methods in the present disclosure should not be construed as reflecting the following intention: that is, the present disclosure claimed to be protected is required to have more features than those clearly set forth in each claim. Or rather, as reflected in the claims, the disclosure aspects aim to be fewer than all features of a single embodiment disclosed above.

Optional implementations of the present disclosure are described in detail below. Under the foregoing indoctrination of the present disclosure, a person skilled in the art may make other improvements or modifications based on the foregoing embodiments. A person skilled in the art should understand that, the foregoing specific description only better explains the purpose of the present disclosure, and the protection scope of the present disclosure is subject to the protection scope of the claims.

What is claimed is:

1. An electronic transaction processing method, applied to a server, and comprising:
receiving a self-verification request sent by a payee terminal for an order transaction;
determining whether transaction verification information carried in the self-verification request matches verification information of the order transaction stored in the server, wherein the verification information of the order transaction is sent to an associated payer account when the order transaction is successful; and
if the transaction verification information carried in the self-verification request and the verification information of the order transaction in the server match, not carrying out reversal processing.

2. The method according to claim 1, further comprising:
carrying out the reversal processing if the transaction verification information carried in the self-verification request does not match the verification information of the order transaction.

3. The method according to claim 1, wherein the determining whether transaction verification information carried in the self-verification request matches verification information of the order transaction stored in the server comprises:
determining whether the transaction verification information is consistent with the verification information and whether the transaction verification information is valid;
determining, if the transaction verification information is consistent with the verification information and the transaction verification information is valid, that the transaction verification information matches the verification information; and
determining, if the transaction verification information is not consistent with the verification information or the transaction verification information is invalid, that the transaction verification information does not match the verification information.

4. The method according to claim 3, further comprising:
adding a self-verification success mark for the order transaction if the transaction verification information matches the verification information of the order transaction.

5. The method according to claim 1, further comprising:
receiving a query request that comprises order information and that is sent by the payee terminal;
querying, according to the query request, a transaction result of an order transaction corresponding to the order information;
returning the transaction result to the payee terminal.

6. The method according to claim 1, further comprising:
receiving a transaction processing request sent by the payee terminal for the order transaction, and generating the verification information of the order transaction.

7. The method according to claim 6, wherein the receiving a transaction processing request sent by the payee terminal for the order transaction, and generating the verification information of the order transaction comprises:
generating, if the transaction processing request is received, the verification information according to a daily check number and an encoding mode set for a target date; and
sending, in a case that the order transaction is successful, the verification information to the associated payer account.

8. The method according to claim 7, wherein
the daily check number is a natural number between 16 and 128; and
the encoding mode is an encoding mode for encoding characters in a designated character set on the target date.

9. The method according to claim 8, wherein the encoding characters in a designated character set on the target date comprises:
performing, according to the encoding mode corresponding to the target date, binary Huffman coding on the characters in the designated character set, to enable an average value of encoding lengths of the encoded characters to be within a threshold range, wherein the threshold range is determined by the daily check number of the target date.

10. The method according to claim 9, further comprising:
receiving a sign-in packet sent by the payee terminal on the target date, and sending the daily check number and the encoding mode corresponding to the target date to the payee terminal.

11. The method according to claim 10, wherein
the received transaction processing request further comprises transaction verification information and order information of another order transaction, and an occurrence time of the another order transaction is earlier than that of the order transaction, and a self-verification of the another order transaction is already successful at the payee terminal; and
the method further comprises:
verifying self-verification validity of the another order transaction.

12. The method according to claim 11, wherein the verifying self-verification validity of the another order transaction comprises:
restoring, according to the encoding mode corresponding to the target date, characters in the transaction verification information of the another order transaction to corresponding binary Huffman codes, and calculating a sum of lengths of the binary Huffman codes corresponding to the characters in the transaction verification information to obtain a calculation result;
determining whether the calculation result is equal to the daily check number corresponding to the target date; and
determining that the self-verification is valid in a case that the calculation result is equal to the daily check number, and determining that the self-verification is invalid in a case that the calculation result is not equal to the daily check number.

13. An electronic transaction processing method, applied to a payee terminal, and comprising:
sending a transaction processing request comprising order information to a server;
providing, in a case that a transaction result returned by the server for the transaction processing request is not received in a first target duration,
an input interface of transaction verification information, and obtaining transaction verification information through the input interface;
adding the obtained transaction verification information into a self-verification request;
sending the self-verification request to the server.

14. The method according to claim 13, wherein the obtaining transaction verification information through the input interface comprises:
obtaining transaction verification information in a deduction notification of an associated payer account through the input interface.

15. The method according to claim 13, further comprising:
outputting prompt information of a successful transaction if a self-verification success message returned by the server is received; and
outputting, if a self-verification failure message returned by the server is received, prompt information that a transaction fails and a reversal is performed.

16. The method according to claim 13, further comprising:
performing, in a case that the transaction result returned by the server is not received in the first target duration and before the step of obtaining the transaction verification information through the input interface is performed, any one of the following steps:
sending a query request comprising the order information to the server, and performing, if a transaction result is still not found in a second target duration, the step of providing an input interface of transaction verification information; and
providing a reversal option, and sending a reversal request comprising the order information to the server if the reversal option is triggered.

17. The electronic transaction processing method according to claim 13, further comprising:
performing, in a case that a self-verification result returned by the server is not received in the third target duration, self-verification according to a check rule from the server and the obtained transaction verification information.

18. The method according to claim 17, wherein the performing self-verification according to a check rule from the server and the obtained transaction verification information comprises:
restoring, according to the encoding mode of the target date, characters in the obtained transaction verification information to corresponding binary Huffman codes, and calculating a sum of lengths of the binary Huffman codes corresponding to the characters in the transaction verification information to obtain a calculation result; and
determining whether the calculation result is equal to the daily check number of the target date; and determining that the self-verification is successful in a case that the calculation result is equal to the daily check number, and determining that the self-verification fails in a case that the calculation result is not equal to the daily check number.

19. The method according to claim 18, further comprising:
adding transaction verification information and order information corresponding to an order transaction whose self-verification is successful into a transaction processing request of another order transaction and uploading the transaction processing request to the server for the server to verify self-verification validity of the order transaction whose self-verification is successful, wherein an occurrence time of the another order transaction is later than that of the order transaction whose self-verification is successful.

20. A reversal processing system, comprising:
a server, comprising a processor and a storage medium configured to store executable instructions of the processor, the processor being configured to execute instructions stored in the storage medium, to implement the following steps:
receiving a self-verification request sent by a payee terminal for an order transaction;
determining whether transaction verification information carried in the self-verification request matches verification information of the order transaction stored in the server, wherein the verification information of the order transaction is sent to an associated payer account when the order transaction is successful; and
if the transaction verification information matches the verification information of the order transaction, not carrying out reversal processing; and
at least one payee terminal, comprising a processor and a storage medium configured to store executable instructions of the processor, the processor being configured to execute instructions stored in the storage medium, to implement the following steps:
sending a transaction processing request including order information to the server;
if a transaction result returned by the server for the transaction processing request is not received in a first target duration,
providing an input interface of transaction verification information, and obtaining the transaction verification information through the input interface;
adding the obtained transaction verification information into a self-verification request;
sending the self-verification request to the server.
